(19) United States
(12) Patent Application Publication
(10) Pub. No.: US 2013/0325645 A1
(43) Pub. Date: Dec. 5, 2013

(54) Semi-Anonymous Request-Offer Matching Commerce Mobile App

(71) Applicant: Shibu A. Thomas, Millstone Township, NJ (US)

(72) Inventor: Shibu A. Thomas, Millstone Township, NJ (US)

(21) Appl. No.: 13/906,435

(22) Filed: May 31, 2013

Related U.S. Application Data
(60) Provisional application No. 61/653,522, filed on May 31, 2012.

(51) Int. Cl. G06Q 30/06

(52) U.S. Cl. CPC G06Q 30/0615
USPC 705/26.3

(57) ABSTRACT

A smart-device application (app) enables businesses and customers to conduct semi-anonymous transactions. A customer initiates a specific but anonymous acquisition-request. A secure core-module operating on a web-server parses the request and assesses which businesses are most likely to respond, and sends the request to them. Any of these businesses may respond by sending an anonymous supply-offer back to the core-module, which is relayed on to the customer without any information identifying the potential supplier. The shopper selects two offers and submits an indication of interest in them to the core-module. More detailed information regarding the businesses is then sent to the customer, who elects to purchase from one of them by sending an offer of acceptance to the core-module. A deal confirmation is sent to both parties. The customer then rates the experience and a social medium message is sent to a social media site.

### CLAIM OF PRIORITY

This application claims the priority of U.S. Ser. No. 61/653,522 filed on May 31, 2012, the contents of which are fully incorporated herein by reference.

### FIELD OF THE INVENTION

The invention relates to smart-device apps that enable customers and businesses to interact and trade in a semi-anonymous way, and more particularly to a semi-anonymous request-offer matching commerce mobile app that allows a customer to anonymously request a product or a service, and a business to make an anonymous bid for that product or service, and only reveal relevant personal information after the customer has made an initial indication of interest.

### BACKGROUND OF THE INVENTION

Internet trading of goods and services has become an established industry as evidenced by the success of such entities as Amazon.com, E-Bay, Craig's list and Angie's list that have largely replaced off-line, or print, markets such as the “Wanted Ads” in national and local newspapers.

While popular, these on-line services have shortcomings. One such shortcoming is that offerings tend to be posted in a bulletin board fashion, covering general areas. This may be tedious for customers, who need to try and guess which of the generally relevant businesses provides their current, exact requirements. Secondly, the business can only make offers that are open to all, so they cannot, for instance, heavily discount one model of and item for one customer, while maintaining a higher price for all other customers.

The large, centralized web businesses, such as, but not limited to, E-Bay™ or Amazon™ are typically not local businesses, so that items they sell cannot be “tried on” or touched before purchasing them, and obtaining the items typically means having to ship them, which may be costly and may introduce delays in receiving them and extra work and expense in returning any items.

There is also another group of online businesses such as, but not limited to, Groupon™ and Living Social™ that offer discounts but may force discounts on businesses that are unsustainable and cannot be maintained by the businesses obligated to fulfill the orders.

The business-customer semi-anonymous trading app of this invention may solve these, and related problems, and provide a more flexible and targeted shopping experience that may be of benefit to both customers (aka byer or shoppers) and businesses (aka suppliers or sellers).

In particular, the semi-anonymous request-offer matching commerce mobile app of this invention may offer a level playing field to businesses, it may encourage people to support local business, and it reduces the need for business to advertise or to send spam type emails with random, untargeted adverts that create noise and clutter for customers.

### DESCRIPTION OF THE RELATED ART

The relevant prior art includes:

U.S. Pat. No. 7,110,976 to Heimermann, et al. issued on Sep. 19, 2006 entitled “Centralized, requisition-driven, order formulating, e-procurement method using reverse auction” that describes a system and methods for providing a fully automated, requisition-driven, “Just-In-Time” supply-based, centralized e-procurement system, suitable for governments or entities with similar procurement needs. A Web site-based reverse-auction among competing authorized suppliers is employed for purchase of all goods and services, except those that must be procured by other means. Automated methods are provided for: requisition handling and pooling; order formulation; processing and tracking; consolidated, distributed and other shipping arrangements; procurement accounting and payment authorization; supplier-relations administration; centralized e-procurement catalog management; procurement data analysis, and report and alert generation; procurement-needs analysis; and inventory management. A structure of internal and external modules is created for security. To the extent possible, all communication from and to and within the system is performed digitally.

U.S. Pat. No. 7,693,752 to Jaramillo issued on Apr. 6, 2010 entitled “Mobile commerce framework” that describes a subscription-based system for providing commerce information for one or more mobile devices for one or more businesses. Some techniques employed feature a subscription-based method for presenting commercial resources to a mobile device. The method involves receiving mobile device user information relating to a geographic location to locate one or more businesses within a subscription-based shopping network, and receiving mobile device user information relating to a type within the subscription-based shopping network. The method also involves receiving, from a database over a communication network, information for one or more businesses associated with the mobile device user information for the geographic location and the business type, and presenting the associated business information on the mobile device. The associated business information can include a business name and address, a business telephone number, a business advertisement, a business coupon, or a business product or service offering to subscribers of the shopping network.

U.S. Pat. No. 8,121,904 to Johnson issued on Feb. 21, 2012 entitled “Electronic proposal preparation system” that describes an electronic system for creating customized product proposals stores a plurality of pictures and text segments to be used as building blocks in creating the proposal. The pictures may include various products, environments in which the products may be used, and available product options. The text segments may include textual descriptions of the product, environments in which the product may be used, and its performance specifications. The system queries a user to determine a customer's needs and interests. Based upon the answers to the queries, the system selects the appropriate picture and text building blocks to fill in proposal templates. The system can print the completed proposal templates to provide the user with a customized, printed proposal that describes features and benefits of a product, in a particular environment, that are of interest to the customer who is to receive the proposal.

U.S. Pat. No. 7,689,463 to Mesaros issued on Mar. 30, 2010 entitled “Multiple supplier system and method for transacting business” that describes a system and method for conducting electronic business between buyers and sellers is provided. The system and method disclose a means for at least one buyer to request and receive online bids from one or more sellers of a particular product according to a price curve or price schedule. A price schedule or curve for a product defining a product's unit price as a function of the volume of product ordered. Upon receipt of a plurality of bids from sellers, a buyer can then select a seller-supplier based at least in part on the price schedule.

Various implements are known in the art, but fail to address all of the problems solved by the invention described herein. One embodiment of this invention is illustrated in the accompanying drawings and will be described in more detail herein below.

### SUMMARY OF THE INVENTION

The present invention relates to systems and methods that include one or more computer application (apps) that may run on one or more smart-devices, enabling businesses and customers to conduct secure transactions in a semi-anonymous manner.

In a preferred embodiment, the app may include computer readable instructions, or program code, that may enable a smart-device to perform a number of transformative actions.

The transformative actions performed by the smart-device may, for instance, include allowing a customer, aka a first registered user, to use the smart-device to initiate an anonymous acquisition-request. This request may include a significant degree of specificity such as, but not limited to, a choice of color, size, price limit, brand name or some combination thereof, and may include an expiration time or date. The request may not be posted on a webpage, but instead may be sent, in encrypted form, over a public communications network such as the Internet, to a secure core-module operating on a secure web-server.

The secure core-module may then parse the shopper's request and assess which business members are most relevant to, or most likely to be in a state to respond to the request. The secure core-module may then only send, or relay on, the request to those selected businesses. The request as relayed on may be an anonymous version containing all pertinent information such as, but not limited to, the product or service requirements and conditions, but with nothing that may identify the customer.

One or more of the selected businesses may respond to the offer by sending an anonymous supply-offer to the secure core-module on the secure web-server. This offer may include an expiry time or date. The secure core-module may then relay these offers onto the customer. The secure core-module may supply the shopper with a rating of the business or person making the offer, based on previous customer's comments. The shopper may not, however, receive any information identifying the supplier making the offer.

The request-offer matching commerce app may include an “automated response” feature that allows a business to set up a discount response that will automatically be sent to a request that may match one or more preset rules. The automated response may also have an expiration feature.

The shopper may then select one or more offers that appear to be the best to satisfy their need. In a preferred embodiment, the shopper may, for instance, pick two of the offers, and submit an indication of interest in those two to the secure core-module.

The secure core-module may then send the shopper more detailed information regarding the two businesses they are interested in dealing with.

Armed with this further information, the shopper may make a decision and elect to purchase from one particular business and may convey this decision by sending an offer of acceptance to the secure core-module. The offer of acceptance may then recorded the details of the purchase, and may send a deal confirmation to both parties.

In further embodiments, the shopper may rate the experience or the seller.

In yet a further embodiment, the secure core-module may automatically send a social medium message to one or more social media site relevant to the buyer, the seller or the service.

Therefore, the present invention succeeds in conferring the following, and others not mentioned, desirable and useful benefits and objectives.

It is an object of the present invention to provide a semi-anonymous request-offer matching commerce app for all smart-devices.

It is another object of the present invention to provide an easy way for businesses to draw attention to themselves via social network sites.

Yet another object of the present invention is to provide shoppers with an easily navigated, user rated way to make very specific purchases at bargain prices.

Still another object of the present invention is to provide businesses with an easy way to discard of overstock items quickly and at a reasonable price, without negatively impacting the rest of their business.

Still another object of the present invention is to provide a secure way for local businesses and shoppers to find each other.

### BRIEF DESCRIPTION OF THE DRAWINGS

FIG. 1 shows a schematic overview of an embodiment of a business-customer semi-anonymous trading app of this invention being used.

FIG. 2 shows a schematic flow diagram of some of the steps used by a semi-anonymous trading app of this invention.

FIG. 3 shows a schematic overview of an exemplary embodiment of a trading app of this invention.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

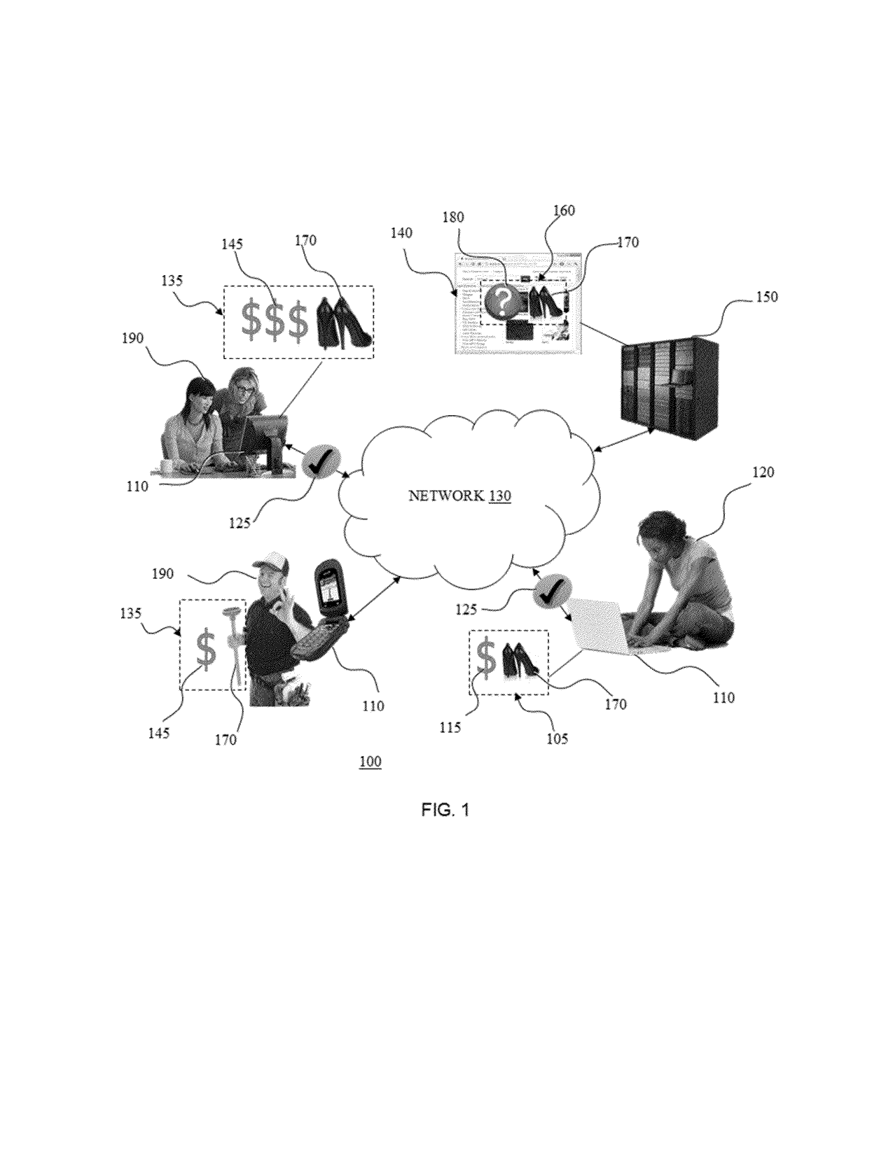

FIG. 1 shows a schematic overview of an embodiment of a business-customer semi-anonymous trading app of this invention being used.

In a preferred embodiment of the present invention, a shopper, who may be a registered member 120 of a secure website 141 operated by a secure core-module 140 that may specialize in the trade of goods or services, may use a smart device 110 to connect, via a public communications network 130 to a secure web-server 150 that may be hosting a secure core-module 140.

The first registered member 120, aka the shopper, may select to initiate an anonymous acquisition-request 160. This anonymous acquisition-request 160 may be sent to a secure core-module 140 that is operative on the secure web-server 150. The anonymous acquisition-request 160 may, for instance, include a product, a restaurant or a service 170 and one or more acquisition parameters 180. For example the product or a service 170 may, for instance, be a consumer product such as, but not limited to, a pair of shoes, an item of clothing, a kitchen appliance, an item of food, or some combination thereof. The acquisition parameters 180 may define that product or a service 170 more precisely. For instance, the acquisition parameters 180 may, for instance, include, if the item is a shoe, a further requirement such as, but not limited to, a size, a color, a brand, a style and a price limit, or some combination thereof. The acquisition parameters 180 may also include a date or time on which the request expires.

Having received the anonymous acquisition-request 160, the secure core-module 140 may automatically parse or analyze the request, and obtain details of the request. The secure core-module 140 may, for instance, identify from a database it may be attached to, one or more businesses that would be suited to supplying the anonymous acquisition-request 160. These businesses, aka second registered members 190, that are deemed by the secure core-module 140 to be the most likely to respond to the anonymous acquisition-request 160, may then be informed of the anonymous acquisition-request 160. Informing may be done by any suitable practice, such as, but not limited to, email, telephone call, IM, text message, regular mail, webpage, a message within the native app, or some combination thereof.

The selected businesses, or second registered members 190, may, or may not, elect to respond to the anonymous acquisition-request 160. In the event that they respond, their responses may be received by the secure core-module 140. Responses judged to be appropriate may then be forwarded, stripped of any unnecessary identification, by the secure core-module 140 to the first registered member 120, or at least the smart device 110 being used by the first registered member 120. While it is expected that the registered member information 120 can be maintained as anonymous, in another embodiment it may also be possible to turn off the anonymity feature, allowing the customer to see the name of the merchant and all other details.

The first registered member 120 may then select one or more of the responses to investigate more fully. In a preferred embodiment of the present invention, the first registered member 120 may, for instance, select two of the offers. Having selected two offers, the first registered member 120 may inform the secure core-module 140 of their choice by sending a offer of acceptance 125 to the secure core-module 140. After ensuring that the offer of acceptance 125 from the first registered member 120 is genuine and, if appropriate, sufficiently funded, the secure core-module 140 may then issue a deal confirmation 126 to both the first registered member 120 and the second registered member 190. The deal confirmation 126 sent to the shopper and the business may include, or be accompanied by, an authorization code 127. The authorization code 127 may, for instance, be used in guarantying authenticity of the deal, or any party to the deal. The deal confirmation 126 may also include all relevant contact details not already exchanged.

Once the deal between the first registered member 120 and the second registered member 190 for the product or a service 170 is completed, one or both of the parties may be invited to submit a rating of the experience. This rating may, for instance, be used in informing shoppers or businesses in future, or concurrent, transactions.

In addition, once the transaction is completed, the secure core-module 140 may send a social medium message 325 to a suitable social media site 330 that may be frequented by either the first registered member 120 or the second registered member 190.

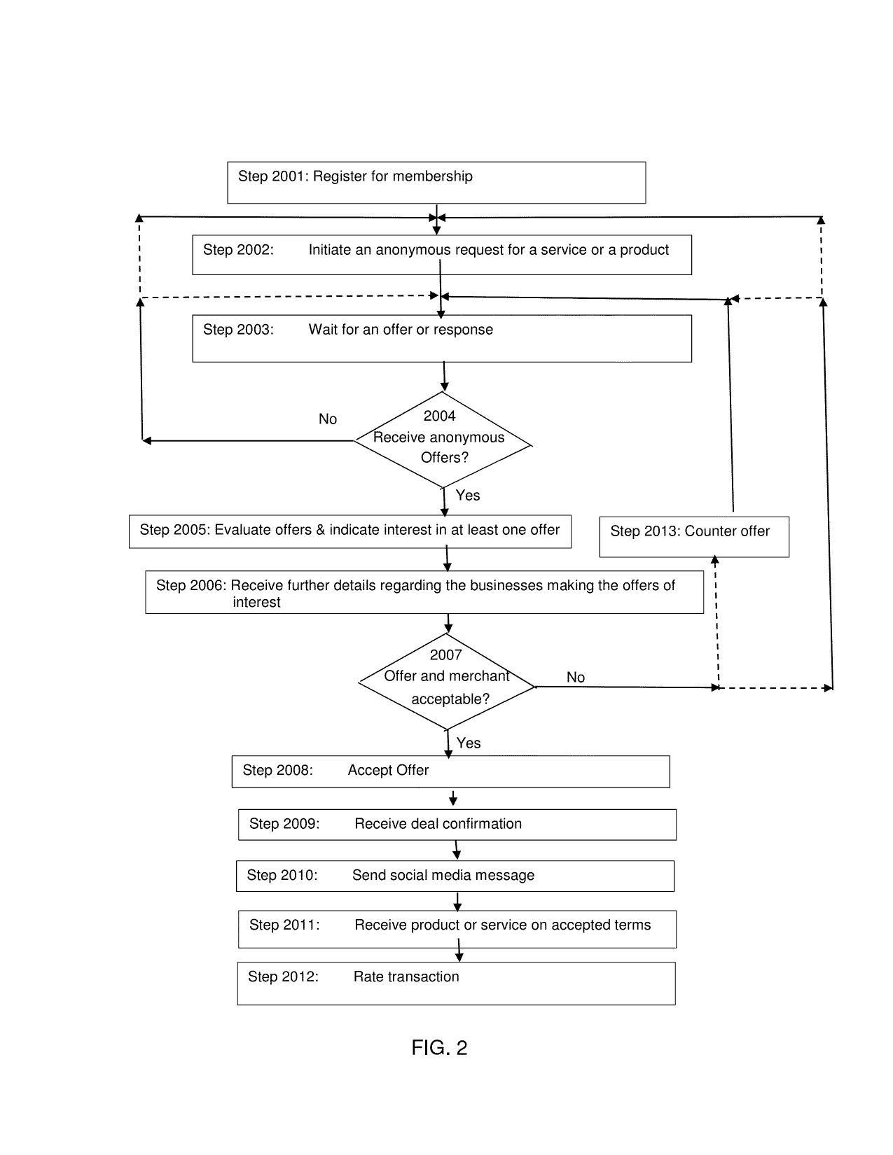

FIG. 2 shows a schematic flow diagram of some of the steps used by a semi-anonymous trading app of this invention.

Step 2001: Register for membership. In this step an individual or business my become a registered member 120 of a group, cooperative or other collection of persons and businesses having trading goods and services amongst themselves as at least one objective of their association. Such membership may require items such as, but not limited to, recommendations, authentication of identity and membership dues, or some combination thereof. The benefits of such membership may include items such as, but not limited to, access to a secure website 141 that allows a registered member to participate in business-customer semi-anonymous trading with other members by means of a suitably coded semi-anonymous request-offer matching commerce mobile app 100 that may be operable on a variety of smart devices such as, but not limited to, smart-phones, smart pads, e-book readers, personal computers or some combination thereof.

When logging in to register for membership, the business may enter information into a database regarding the specific products, services or food items that they may normally offer. The businesses may also suggest items that they would like to offer.

Shoppers may also be able to suggest items that may be of interest to them but are not currently listed on the database of available items.

Step 2002: Initiate an anonymous request for a service or a product. In this step a registered member may initiate an anonymous acquisition-request 160. This request may, for instance, be for a product or a service 170 to be supplied subject to certain parameters such as, but not limited to, within a particular price range, a particular geographic location, a particular time frame or some combination thereof.

The anonymous acquisition-request 160 may be sent by a first registered member 120 to a secure core-module 140 that may be operable on a secure web-server 150. The secure core-module 140 may be programmed so as to parse or analyze the anonymous acquisition-request 160, and use the information gleaned from such an analysis to identify one or more other registered members who may be equipped to, or interested in, responding to such a request. The secure core-module 140 may then sanitize the anonymous acquisition-request 160, removing information such as, but not limited to, any information that may be used to identify the first registered member 120. The secure core-module 140 may then circulate the sanitized anonymous acquisition-request 160 to that group of other members who may have been identified as most likely to be interested in, or equipped to, respond to the request.

Step 2003: Wait for an offer or response. The first registered member 120 may now need to wait until the processes above may be completed and the other registered users have time to respond to the request.

If after a reasonable about of time waiting, which may vary, from a few hours to a few days, dependent on the nature of the acquisition-request 160, no offers are received, the first registered member 120 may choose to either return to steep 2003 and continue to wait, or to go back to step 2002 and initiate a new request that may be altered to attract more of a response.

If, in step 2004, one or more anonymous supply-offers 105 are received, the registered member 120 who initiated the request may then proceed to step 2005.

Step 2005: Evaluate offers & indicate interest in at least one. In a preferred embodiment, at this step the shopper may indicate an interest in up to two of the offers. Once the indication of interest is sent to the secure core-module 140, all the other offers may disappear from the smart device 110 of the first registered member 120. The secure core-module 140 may, however, send further information to the first registered member 120 regarding the selected offers which may be received by the first registered member 120 in step 2006.

In particular, in step 2006, the customer may receive further details regarding the businesses making the offers of interest. These further details may include items such as, but not limited to, the business name, physical location, web-address, owner, further recommendations, images or other promotional material related to the products or services being offered, or some combination thereof.

In step 2007, the shopper has to decide if either of the offers and businesses is acceptable. If they are not, the shopper may loop back to step 2003 of waiting for a response via step 2013 by making a counter offer to the business. Or the shopper may simply loop back to step 2003 and wait for further offers, or the shopper may loop back to step 2002 and initiate a new, or further, offer with altered parameters.

If the offer and business are acceptable to the shopper, they may proceed to step 2008 and accept the offer. To accept the offer the shopper (aka customer aka first registered member 120) may send an acceptance of offer message to the secure core-module 140.

The secure core-module 140 may verify relevant details and may then, in step 2009, send a deal confirmation to both the selected business and the shopper. The deal confirmation may include contact information if that has not already been exchanged. The confirmation may also include details on a time length for which the offer is good, i.e., a date and time after which the offer may expire and may no longer be valid. The business and the customer may specify different expiry times.

The deal confirmation may also initiate step 2010 in which a message congratulating the shopper on receiving such a bargain from the business may be sent to an appropriate media site such as, but not limited to, Facebook™, MySpace™, Twitter™, Four-square™ or some combination thereof.

Once payments have been processed, the shopper may then, in step 2011, receive the product or a service 170 on the terms agreed to by all parties.

In step 2012 the shopper may then rate the transaction experience and/or the business who supplied the product or a service 170. Such a review may be used to rate businesses for the guidance of future customers.

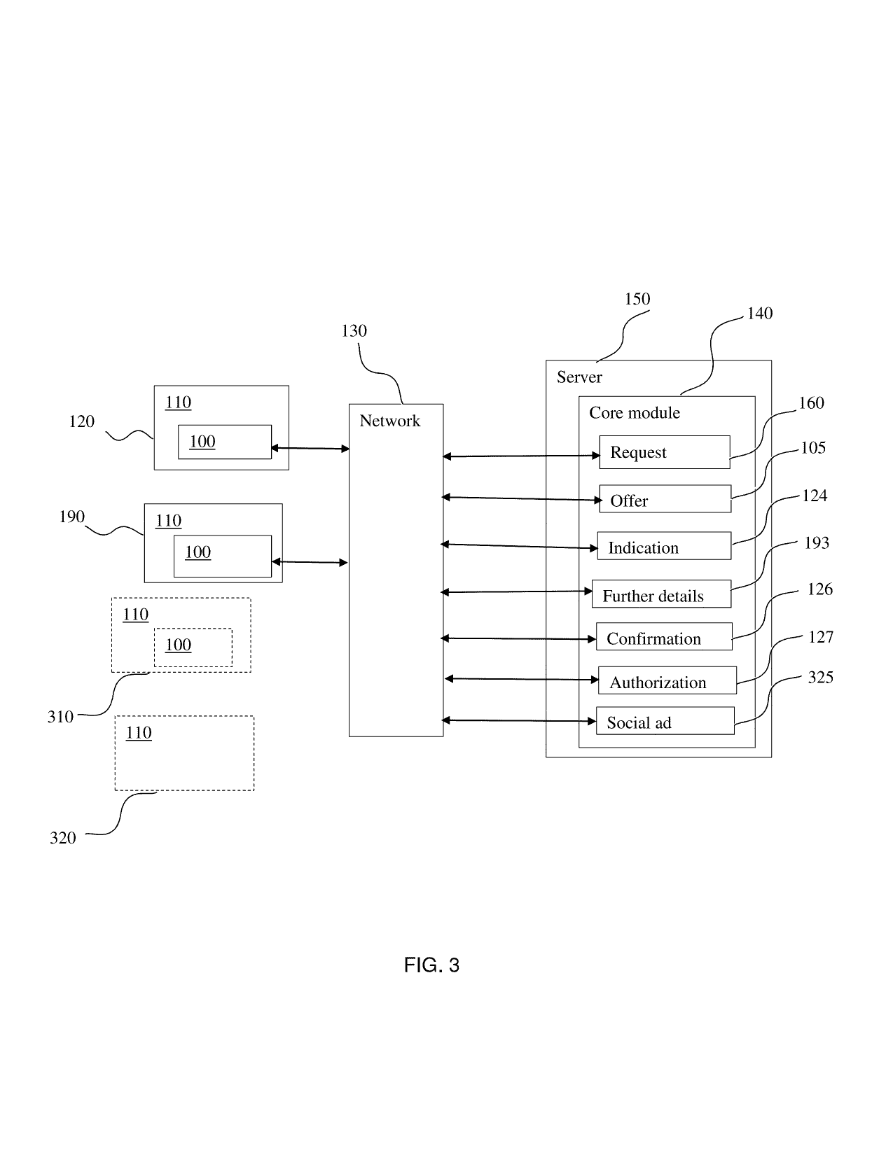

FIG. 3 shows a schematic overview of an exemplary embodiment of a trading app of this invention.

FIG. 3 shows a first registered member 120, who may be a customer or shopper, and a second registered member 190, who may be a business or supplier, interacting with a secure core-module 140 running on a secure web-server 150 via a public communications network 130.

Both the first registered member 120 and the second registered member 190 may be using a smart device 110 to make the connection to the public communications network 130, and each of them may have a semi-anonymous request-offer matching commerce mobile app 100 running on their smart device 110.

The smart device 110 may, for instance, be a digital data processor driven device such as, but not limited to, a smart-phone, a smart tablet, a e-reader or a personal computer or some combination thereof.

The semi-anonymous request-offer matching commerce mobile app 100 may be a programmed set of instructions that may enable a smart device to interact with the secure core-module 140 on the secure web-server 150.

As discussed previously, the secure core-module 140 performs a variety of functions that typically include the following:

Receiving anonymous acquisition-requests 160 from shopper/customers such as, for example, first registered member 120. The member may first be identified either by the secure core-module 140 or by some suitable security module operable on the secure web-server 150. This identification process may be a standard member-name and matching password type process to ensure that the first registered member 120 may be registered and may be current on any financial or other dues relevant to their membership of the trading group represented on the secure web-server 150.

On receiving an anonymous acquisition-request 160, the secure core-module 140 may process the request and, by a suitable method such as, but not limited to, matching the product or service 170 and, the acquisition parameters 180 to equivalent products, services and parameters of sellers or businesses. This matching may, for instance, be performed using a database of membership information and the acquisition parameters 180 may be limitations such as, but not limited to, brand, size, price or price range, geographic location, type of payment, time limits on the transaction or some combination thereof. The type of payment may be cash, check, credit card, barter, swap or some combination thereof. In a request for service such as, but not limited to, decorating, gardening, trash removal or some combination thereof, a parameter may include an estimated amount of labor required which may be specified in minutes, hours, days or any other suitable unit of combinations thereof.

Once a list of businesses that appear likely to respond has been created, the secure core-module 140 may send them a sanitized version of the anonymous acquisition-request 160. This sanitized version may, for instance, have had any personal information regarding the shopper removed, and may also have had parameters considered by the secure core-module 140 to be unimportant or irrelevant, removed.

Having received the sanitized request, one or more of the recipients may respond with an anonymous supply-offer 105. The secure core-module 140 may receive the anonymous supply-offer 105, sanitize them and then relay the sanitized anonymous supply-offers 105 on to the first registered member 120. Sanitizing the anonymous supply-offer 105 may include removing offer parameters that might identify the potential supplier, or business, so as to create a more level playing field amongst suppliers. Sanitizing may also involve removing any unlawful aspects of an offer or any parameters considered to be advertising or solicitation of a type that may be prohibited by the conditions of membership of the trading group. In addition the offers relayed on to the potential buyers may include a rating of each of the potential suppliers, and that rating may, in part, be determined by feedback from shoppers in previous transactions. The secure core-module 140 may also require some level of proof from the potential supplier that their offer differs in a monetarily significant way from a corresponding usual retail supply-offer parameter in a usual retail supply-offer. In other words, there may a threshold, such as, but not limited to, a minimum percentage off a similar offer being made by the same business via a different retail outlet.

The first registered member 120 may then be sent all the relevant offers that have been received by the secure core-module 140. The first registered member 120 may then narrow the field down, and select a subset of the total. In a preferred embodiment, this subset is preferably two offers the buyer is most interested in. Once the secure core-module 140 receives an indication of interest 124 in a subset of the offers, all other offers may be removed from consideration and may no longer be available to the shopper, aka the first registered member 120.

In addition, after receiving an indication of interest 124 in a subset of supplies, the secure core-module 140 may supply the first registered member 120 with further details 193 relating to that subset. The secure core-module 140 may, for instance, now supply the potential buyer with relevant details such as, but not limited to, the sellers name, and the seller's geographic location, or some combination thereof. The secure core-module 140 may also, at this juncture, supply photographs of an item, or that are indicative of a service, or a combination thereof, as a further aid to the shopper in making a choice.

The buyer may then decide on one of the sellers and send the secure core-module 140 a deal confirmation 126. The secure core-module 140 may then notify both first registered member 120 and second registered member 190 of the deal confirmation 126 and may also supply both with an authorization code 127 so that when they establish a direct contact, they may know they are in contact with the party with whom they expected to be in contact. The authorization code 127 may be any suitable means of establishing an identity such as, but not limited to, a common alpha-numeric string, a matching alpha-numeric string, a bar code, a Q code or some combination thereof.

Once the deal has been confirmed the secure core-module 140 may initiate the sending of a message to a social media site in the form of a social medium message 325. In some embodiments of the invention, either the first registered member 120 or the second registered member 190 may have some degree of veto rights over the sending of the social medium message 325.

In a further, preferred embodiment of the semi-anonymous request-offer matching commerce mobile app of the present invention, the app may include an auto-reply function. The auto-reply function may, for instance, t automatically responds to a request that matches at least one pre-set rule. The rules may, for instance, include a geographic location, an item type, a brand type, a size range, a date range or some combination thereof. The auto-reply function may respond to the request with an offer that may, for instance, include a preset discount valid only at preset times on a preset range of items or services. The preset function may also include an expiration setting that allows the business to automatically respond to offers for a preset length of time.

One of ordinary skill in the art will appreciate that the method of this invention may be operated as a business with income originating in membership fees, from trade commissions or a combination thereof. A membership fee may, for instance, take the form of a one-time use fee, an annual membership, or a multiyear membership. The business may also use other incentives such as, but not limited to, additional discounts for more committed grades of membership

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1: A semi-anonymous request-offer matching commerce mobile app, comprising:
computer readable instructions for enabling a smart device to perform one or more transformative actions, comprising:
initiating an anonymous acquisition-request by a first registered member, via a public communications network, to a secure core-module operable on a secure web-server;
receiving, by said first registered member, an anonymous supply-offer relayed from a second, registered member by said secure core-module, said second registered member having been determined by said secure core-module to have a relevancy-to-request quotient above a predetermined relevancy quotient threshold, said relevancy-to-request quotient determined, in part, by said secure core-module;
sending, by said first registered member to said secure core-module, an indication of interest in said anonymous supply-offer;
receiving, by said first registered member from said secure core-module, trading details 193 related to said second registered member;
sending, by said first registered member to said secure core-module, an offer of acceptance; and
receiving, by said first registered member, a deal confirmation relayed from said second registered member by said secure core module.

2: The app of claim 1, wherein said anonymous acquisition-request further comprises at least one acquisition parameter.

3: The app of claim 2, wherein said acquisition parameter comprises a description an item selected from the group comprising consumer goods, consumer services, food items and restaurant reservations.

4: The app of claim 2, wherein said acquisition parameter comprises a geographic location.

5: The app of claim 1, wherein one of said acquisition parameter comprises an indication of an acceptable method of payment selected from one of cash, a check or a credit card.

6: The app of claim 1, wherein one of said acquisition parameter comprises an indication of an acceptable method of payment selected from one of a trade or barter.

7: The app of claim 1, wherein said anonymous supply-offer contains at least one supply-offer parameter that differs in a monetarily significant way from a corresponding usual retail supply-offer parameter in a usual retail supply-offer.

8: The app of claim 1, wherein said transformative actions further comprise sending, by said secure core-module on receipt of said offer of acceptance from said first registered member, an authorization code to both said first registered member and said second registered member.

9: The app of claim 1, wherein said transformative actions further comprise sending, by said secure core-module on receipt of said offer of acceptance from said first registered member, a social medium message to a social media site.

10: The app of claim 1, wherein said transformative actions further comprise indicating a service rating by said first registered member to said secure core-module.

11: The app of claim 1, wherein said requirement parameters include a scope of service indicator.

12: The app of claim 11, wherein said scope of service indicator is an estimated labor requirement.

13: The app of claim 11, wherein said scope of service includes a time restriction on the supply of the service.

14: The app of claim 1, wherein said anonymous supply-offer contains at least one supply-offer parameter that is a rating by previous customers of said second registered member.

15: The app of claim 1, further comprising an auto-reply function that automatically responds to a request matching at least one pre-set rule with an offer comprising a preset discount.

16: The app of claim 15, wherein said auto-reply function further comprises an expiration setting.
